(19) United States
(12) Patent Application Publication
(10) Pub. No.: US 2007/0281573 A1
(43) Pub. Date: Dec. 6, 2007

(54) Method for Manufacturing Glue-pasting Area of Field Emission Display

(76) Inventors: Pu-Hsin Chang, Guanyin Township (TW); Min-Yu Chiu, Guanyin Township (TW); Ta-Wei Liu, Guanyin Township (TW); Ming-Chun Ho, Guanyin Township (TW); Yao-Zong Chen, Guanyin Township (TW)

Correspondence Address: HDSL, 4331 STEVENS BATTLE LANE, FAIRFAX, VA, 22033, US

(21) Appl. No.: 11/421,489

(22) Filed: Jun. 1, 2006

(51) Int. Cl. H01J 9/24; H01J 9/32

(52) U.S. Cl. 445/24; 445/25

(57) ABSTRACT

A method for manufacturing glue-pasting area of field emission display forms a plurality of elongated low walls on glue-pasting area of the anode plate or the cathode plate by printing. The elongated low wall includes a length side parallel with a package side of the display. The elongated low walls are arranged on the glue-pasting area in staggered and parallel fashion, where a first gap is defined between two adjacent elongated low walls and the first gap is a channel for overflow glue after the cathode plate is pressed with the anode plate. After the glass glue is pasted on the elongated low wall and the cathode plate is pressed with the anode plate, the overflow glue is constrained b the gap to control the width of glue.

### BACKGROUND OF THE INVENTION

1. Field of the Invention

The present invention relates to a field emission display, especially to a method for manufacturing glue-pasting area of field emission display to control glue-pasting area and device thickness.

2. Description of Prior Art

The conventional flat plat displays (FPD) generally include field emission display (FED), TFT-LCD, plasma display panel (PDP), organic LED (OLED) and projective display. The FPD has the advantages of light weight and compact size, and can be applied to small-screen application such as mobile phone, or medium-to-large screen applications such as computer monitors or television monitors. The FPD can also be useful to ultra-large screen application such as outdoor sign board. The development issues for PDP includes high definition, large screen and longevity.

Carbon nanotube field emission display (CNT-FED) has excellent property for display. The CNT-FED is a display based on field emission, where electrons are emitted from tips of carbon nanotube based electron emitter. The emitted electrons will bombard phosphor layer through vacuum environment due to acceleration force of anode, thus generating light.

The vacuum environment of the field emission display for CNT-FED is established by vacuuming air between an anode plate and a cathode plate such that a vacuum region (or package region) is defined between the anode plate and the cathode plate. To prevent crack of the anode plate and the cathode plate due to the vacuum state therein, spacer or rib are provided between the anode plate and the cathode plate. The spacer or rib is provided to support the anode plate and the cathode plate, and to prevent short circuit of the conductors on the anode plate and the cathode plate. The vacuum degree in the vacuum region should be less then 10⁻⁶ Torr to prevent unwanted effects such as plasma, low illuminating efficiency and shorter life.

In conventional FED with diode structure, the separation between the anode plate and the cathode plate is supported by rib and the separation is about 40-100 μm. The anode plate and the cathode plate are generally sealed with glass glue during package. The glass glue process will perform two heating steps. The first step is a pre-baking with 350° C.˜400° C. to vaporize the organic solvent in the glass glue. The second step is a sintering with 440° C.˜480° C. The material of the glass glue will be softened and then crystallized to inter-link to macromolecule for enhancing compactness and strength of the package. The material of the glass glue should have coupling strength, low volatility, and low dust. The material of the glass glue with high-temperature link feature should have similar physical property with the glass plates of the anode plate and the cathode plate, namely, sufficient hardness and air-tightness to maintain vacuum degree.

To maintain the separation between the anode plate and the cathode plate and to prevent the presence of air bubble, the glue-pasting area has a specific width, which is accomplished by the separation of the rib and the thickness of the paste after package. Therefore, the width of the glue-pasting area is the extending width of the pasted glue after the glue is pressed. The peripheral of the conventional FED with diode structure has a package area with at least 2 mm package width. If the package width should be less than 2 mm due to product appearance and effective display area, the amount of the glass paste is reduced. However, the porosity ratio of the package area is increased and leaked gas is produced when the package area is narrower. The width of the package area will not be uniform when package area is narrower. Moreover, the supporting force between the anode plate and the cathode plate is weak when package area is narrower. The yield will be reduced and the life of the display is reduced.

### SUMMARY OF THE INVENTION

The present invention is to provide a method for manufacturing glue-pasting area of field emission display, where the flow of the glass glue can be constrained and the separation of anode plates and cathode plates can be sustained. Therefore, the crack problem due to vacuum state can be prevented.

Accordingly, the present invention provides a method for manufacturing glue-pasting area of field emission display. This method forms a plurality of elongated low walls on glue-pasting area of the anode plate or the cathode plate by printing. The elongated low wall includes a length side parallel with a package side of the display. The elongated low walls are arranged on the glue-pasting area in staggered and parallel fashion, where a first gap is defined between two adjacent elongated low walls and the first gap is a channel for overflow glue after the cathode plate is pressed with the anode plate. After the glass glue is pasted on the elongated low wall and the cathode plate is pressed with the anode plate, the overflow glue is constrained b the gap to control the width of glue.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the field emission display according to the present invention.

FIG. 2 shows a sectional view of FIG. 1.

FIG. 3 shows the anode plate of the present invention.

FIG. 4 shows a partially enlarged view of portion A of FIG. 3.

FIG. 5 shows a partially enlarged view of rib of FIG. 2.

FIG. 6 shows glue pasting on rib in FIG. 5.

FIG. 7 shows the coupling of anode plate and cathode plate.

### DETAILED DESCRIPTION OF THE INVENTION

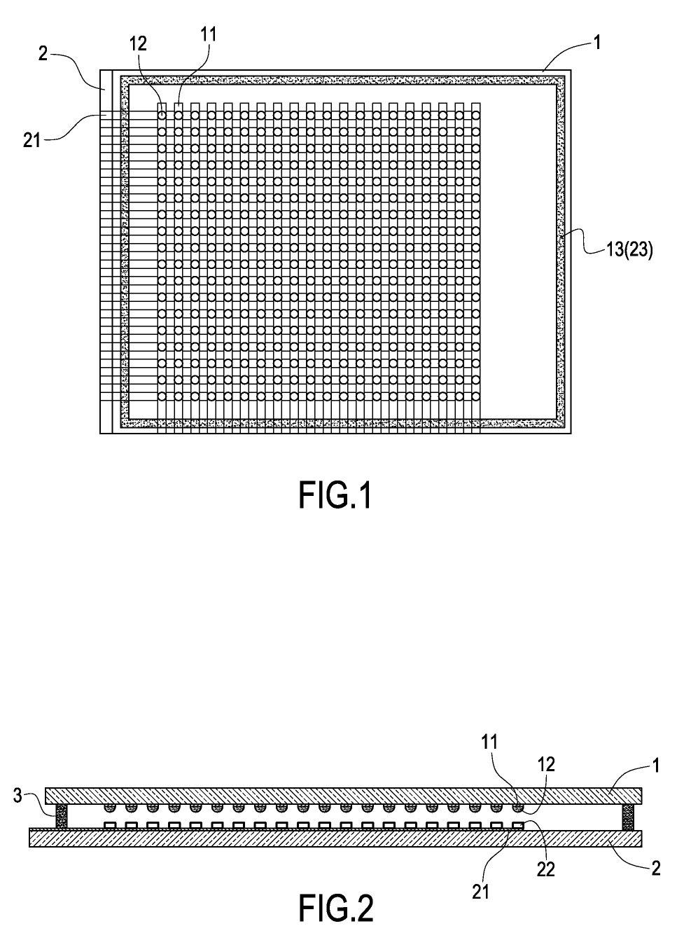

With reference to FIGS. 1 and 2, according to the method for manufacturing glue-pasting area of field emission display of the present invention, the anode plate 1 and the cathode plate 2 are manufactured separately. After the conductive layer 11 and phosphor layer 12 of the anode plate 1 and the conductive layer 21 and phosphor layer 22 of the cathode plate 2 are manufactured, the anode plate 1 is packaged with the cathode plate 2. For packaging the anode plate 1 and the cathode plate 2, ribs 3 are provided on the glue-pasting area 13 (non-display area) of the anode plate 1 and the cathode plate 2. The ribs 3 are then assembled with glue-pasting area 23 of the cathode plate 2. The ribs 3 are attached between the anode plate 1 and the cathode plate 2 to separate the anode plate 1 and the cathode plate 2.

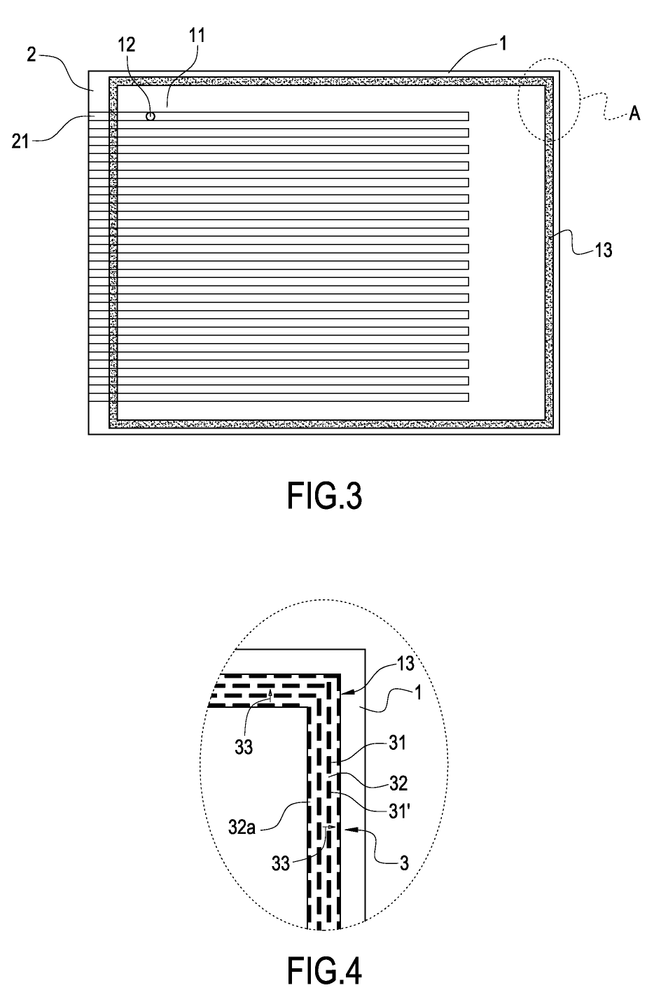

FIG. 3 shows the anode plate of the present invention and FIG. 4 shows a partially enlarged view of the rib in FIG. 2. The rib 3 uses the same glass material with the glass material of the anode plate 1 and the cathode plate 2. The glass material is printed on the glue-pasting area 13 of the anode plate 1 for patterning of the rib 3. In printing process, a plurality of elongated strips are formed on the glue-pasting area 13 of the anode plate 1. Elongated low walls 31 are formed on the elongated strips as shown in FIG. 5. The thickness of the elongated low walls 31 is the required thickness of display or the desired separation between the anode plate 1 and the cathode plate 2. The length side of the elongated low walls 31 is parallel with the package side of the anode plate 1. The elongated low walls 31 are arranged on the glue-pasting area 13 in parallel and staggered fashion. A first gap 32 is defined between two adjacent elongated low walls 31 and 31′ in the different rows.

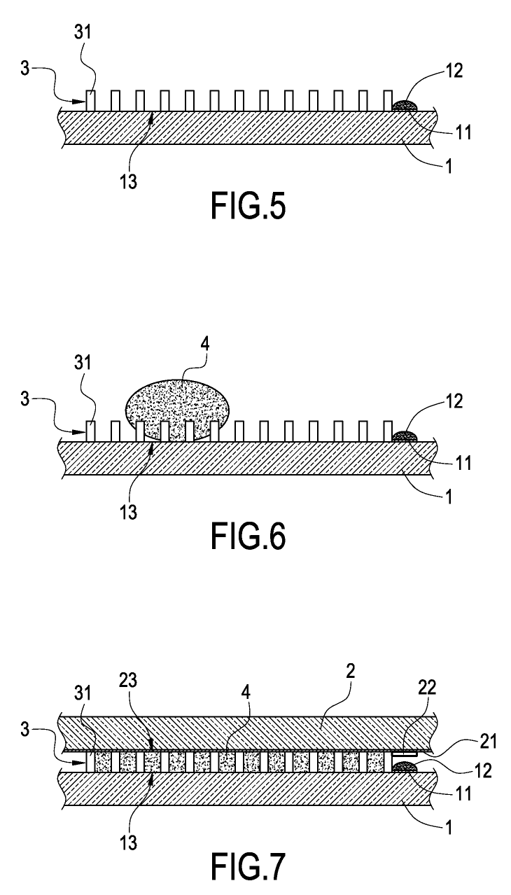

After the elongated low walls 31 are finished by printing, the glass glue 4 is directly applied to the glue-pasting area 13 of the anode plate 11 and covers the elongated low walls 31, as shown in FIG. 6. As shown in FIG. 7, after the anode plate 1 is pressed with the cathode plate 2, the flow of the glass glue is constrained between the elongated low walls 31 such that the width of the glass glue can be controller.

To flow the glass glue 4 uniformly in the glue-pasting area 13 and 23, the elongated low walls 31 can be arranged in staggered fashion. Therefore, the first gap 32 of the elongated low walls 31 and 31′ can be uniformly distributed. The elongated low walls 31 can provide support for the anode plate 1 and the cathode plate 2. Therefore, the crack problem due to only support by glass glue can be prevented.

FIG. 4 shows the partially enlarged view of portion A in FIG. 3. The elongated low walls 31 are elongated structure with length side longer than width side. The elongated low walls 31 can have length of 5-10 mm and width within 200 μm. The elongated low walls 31 are arranged in rows and a continuous elongated first gap 32 is defined between two adjacent elongated low walls 31 in different rows. The overflowed glue can flow along the continuous elongated first gap 32. Second gaps 32a are provided between two adjacent elongated low walls 31 in the same row to define a vertical flow 33 for glue. The adjacent second gaps 32a are staggered to each other to constrain the vertical flow of the glue. Therefore, most of the glue can flow alone the continuous elongated first gap 32 and the air bubble can be prevented to occur, which will influence the vacuum state.

Moreover, the glass glue 4 will expand in shape during sintering. It is disadvantageous to encapsulate the glass glue 4 by an integral low wall 31. Therefore, a plurality of elongated low walls 31 is arranged in staggered fashion to form first gap 32 for facilitating slight flowing of glue. To prevent overflowing of glue outside the package region, the viscosity of the paste material for the glass glue should be more than 50000 cps. The elongated low walls 31 are such arranged that a continuous first gap 32 is defined between two adjacent elongated low walls in the different rows. The elongated low walls 31 are such arranged that the second gap 32a defined between two adjacent elongated low walls in the same row. The second gap 32a near the package region should have a width smaller than 500 μm or equal to 500 μm to constrain flow direction of glue. Therefore, only small amount of overflow glue will be present and the pressing and sintering operation will not be influenced. The length of the gap 32a within the package region also should be constrained. The second gap 32a should be staggered with the second gap 32a outside the package region, and the length of the gap 32a should be smaller than one third of the length of the elongated low wall 31. Therefore, vertical flow 33 of glue can also be constrained.

The elongated low walls 31 arranged in staggered fashion on the glue-pasting area 13 and 23 of the anode plate 1 and cathode 2 have following advantages:

1. The width of the glue-pasting area can be limited within 2 mm.

2. The alignment of the glue-pasting area can be uniform and the glue overflow can be prevented.

3. The package strength and gap of the glue-pasting area can be well controlled and the vacuum effect is enhanced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for manufacturing glue-pasting area of a field emission display, where ribs are formed on glue-pasting areas between an anode plate and a cathode plate, the method comprising:
forming a plurality of elongated strips on the glue-pasting area of the anode plate by printing and the plurality of elongated strips forming elongated low walls after a plurality of printing; and
applying glass glue on the glue-pasting area and covering on the elongated low walls, the elongated low walls confining the glass glue when the anode plate is pressed with the cathode plate, whereby the glass glue flows uniformly to cover the glue-pasting area.

2. The method as in claim 1 wherein the ribs use the same material as glass plate for the anode plate and the cathode plate.

3. The method as in claim 1 wherein the thickness of the elongated low walls is the thickness of display.

4. The method as in claim 1 wherein the thickness of the elongated low walls is a separation thickness between the anode plate and cathode plate.

5. The method as in claim 1 wherein the elongated low wall has a length side parallel with a package side of the anode plate, the plurality of the elongated low walls being arranged in parallel and staggered fashion, a first gap is defined between two adjacent elongated low walls in different rows.

6. The method as in claim 1 wherein the elongated low wall has a length side longer than a width side thereof, the elongated low wall has a length of at least 5-10 mm and a width within 200 μm.

7. The method as in claim 1, wherein a second gap between the adjacent elongated low walls is smaller than 500 μm or equal to 500 μm to prevent flow of over glue.

8. The method as in claim 1 wherein the viscosity of the paste for the glass paste is at least 50000 cps.

9. The method as in claim 1 wherein the gap length is smaller than one third of the length of the elongated low wall to constrain overflow of the glue.
